(19) United States
(12) Patent Application Publication
(10) Pub. No.: US 2009/0007525 A1
(43) Pub. Date: Jan. 8, 2009

(54) METHOD FOR REUSING RETURNABLE PACKAGING

(75) Inventors: Tim Lewis, Shelbyville, IN (US); Steve Kunkemoeller, Cincinnati, OH (US); Adden Wagner, Lexington, KY (US)

Correspondence Address: BAKER & DANIELS LLP, 300 NORTH MERIDIAN STREET, SUITE 2700, INDIANAPOLIS, IN, 46204, US

(73) Assignee: ECOLOGICAL PACKAGING RESOURCES LTD, Cincinnati, OH (US)

(21) Appl. No.: 12/142,694

(22) Filed: Jun. 19, 2008

Related U.S. Application Data
(60) Provisional application No. 60/948,381, filed on Jul. 6, 2007.

(51) Int. Cl. B65D 5/42; G06F 15/16

(52) U.S. Cl. 53/474; 709/203

(57) ABSTRACT

The present invention involves a method for reprocessing and reusing returnable packaging used in industry for the shipment of manufactured goods from a manufacturing to a user, wherein said returnable packaging has a lifecycle that terminates at the completion of a program which utilizes the manufactured goods. The packaging is acquired from a vendor at the completion of a program and catalogued. Cataloguing includes sorting, repairing, cleaning, recycling, and storing the packaging in inventory for future redistribution or reuse. The packaging is shipped to the customers as orders are received. Custom packaging may also be designed, manufactured, and shipped.

### CROSS-REFERENCE TO RELATED APPLICATION

This application claims the benefit of U.S. Provisional Application Ser. No. 60/948,381, filed Jul. 6, 2007, the disclosure of which is expressly incorporated by reference herein.

### BACKGROUND OF THE INVENTION

1. Field of the Invention

The invention relates to methodologies for reusing returnable packaging.

2. Description of the Related Art

Many manufacturing entities utilize a returnable packaging system as part of their lean manufacturing plan. The packaging, including containers and pallets, is used to ship materials from a vendor to a manufacturer. The containers and pallets are typically made of durable plastic and come in a variety of shapes and sizes.

The Kanban system is often implemented as part of a manufacturer's returnable packaging program. Kanban is a method for maintaining inventory levels, where a Kanban card is used to signal the need to generate new shipments as material is consumed. Kanban holders are often attached to a wall of a container to hold these cards. In addition, dunnage is often placed in containers to organize, protect, and divide the shipped material. Dunnage includes any material used for stowing and protecting the cargo in the containers.

One type of manufacturer utilizing returnable packaging, as discussed herein, is an automotive company. In an auto company's returnable packaging system, a vendor designs new reusable packaging specifically for the auto company's new vehicle program. Vendors design the containers according to the shape, weight, and quantity of the auto company's ordered materials.

The auto company purchases this packaging and uses it throughout the vehicle program. Vendors ship materials in the reusable plastic containers to the auto company. Once the materials are emptied from the containers, the auto company sends the packaging back to the vendor. The vendor uses the same containers throughout the vehicle program for subsequent shipments.

At the end of the vehicle program, the auto company typically abandons the returnable packaging and purchases new packaging for the next vehicle program. Because of a short changeover time between programs, the packaging for a new vehicle program must be in place before the old packaging is out of use. In addition, auto companies often do not want to handle the recycling or reusing of old packaging due to time constraints of its management employees, inadequate storage space, and a lack of manpower to sort, clean, and refurbish old packaging. This current practice of purchasing new packaging for each vehicle program creates excess cost and excess energy consumption.

The orphan packaging typically accumulates in the vendor's outside storage area. Several problems arise from the abandonment of the packaging. Besides creating an eyesore to the surrounding area, the vendor's storage areas are a potential legal liability for injury and environmental problems. In addition, the abandoned packaging area becomes a breeding ground for insects and rodents. Because the old packaging is typically not protected from the elements, it often ends up rotting and being sent to a landfill during a clean-up effort. Still, some of the packaging is sold to brokers who resell it to other manufacturers. This creates additional injury and environmental liability issues as well as potential bad publicity for the original auto company and vendor depending on the subsequent manufacturer's end use.

### SUMMARY OF THE INVENTION

The present invention is a method for reprocessing and reusing the returnable packaging used in industry for the shipment of goods from a manufacturer to a user, wherein the returnable packaging has a lifecycle that terminates at the completion of a program utilizing the goods.

The invention contemplates the operation of a returnable container reprocessing entity that acquires ownership of and manages the fate of abandoned returnable packaging used extensively by manufacturers. The targeted returnable packaging includes containers, pallets, lids, and dunnage.

In an exemplary embodiment of the present invention, a method is provided for reusing the packaging used in industry to ship manufactured goods from a manufacturer to a user, wherein the packaging has been abandoned following the completion of a program utilizing the manufactured goods. The method comprises the steps of: acquiring ownership of the packaging; acquiring possession of the packaging; cataloguing the packaging; and shipping the packaging to customers. One example of cataloguing includes sorting the packaging into one of a plurality of groups based on the condition or physical characteristics of the packaging. Another example of cataloguing includes cleaning, refurbishing, and storing the reusable packaging and recycling or scrapping the unusable packaging. Identification codes may be associated with each container as a way of tracking inventory. In a further example of cataloguing, an online inventory is created where customers may access the available inventory to select and order packaging for a new program.

In another exemplary embodiment of the present invention, a method is provided for designing the packaging used to ship manufactured goods from a manufacturer to a user. The method comprises the steps of: receiving a request from a customer for a custom design of packaging; creating the custom design with the customer; selecting reused or recycled packaging from inventory similar to the custom design; and modifying the reused or recycled packaging to best match the custom design. In one example, an interactive CAD program is used to design the packaging with the customer. In a further example, the packaging, including dunnage, is manufactured directly from the CAD program file.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a set of photographs of exemplary returnable packaging referred to in the present invention.

FIG. 2 is a flow chart diagram that illustrates an exemplary embodiment of the overall operation of the present invention.

FIG. 3 is a flow chart diagram of the operation of the present invention relating to acquiring ownership of the orphan packaging.

FIG. 4 is a flow chart diagram of the operation of the present invention relating to acquiring the orphan packaging.

FIG. 5 is a flow chart diagram of the operation of the present invention relating to processing the orphan packaging.

FIG. 6 is a flow chart diagram of the operation of the present invention relating to cataloguing and storing salvaged packaging.

FIG. 7 is a flow chart diagram of the operation of the present invention relating to recycling unusable packaging materials.

FIG. 8 is a flow chart diagram of the operation of the present invention relating to sales and order processing.

FIG. 9 is a flow chart diagram of the operation of the present invention relating to design assistance.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

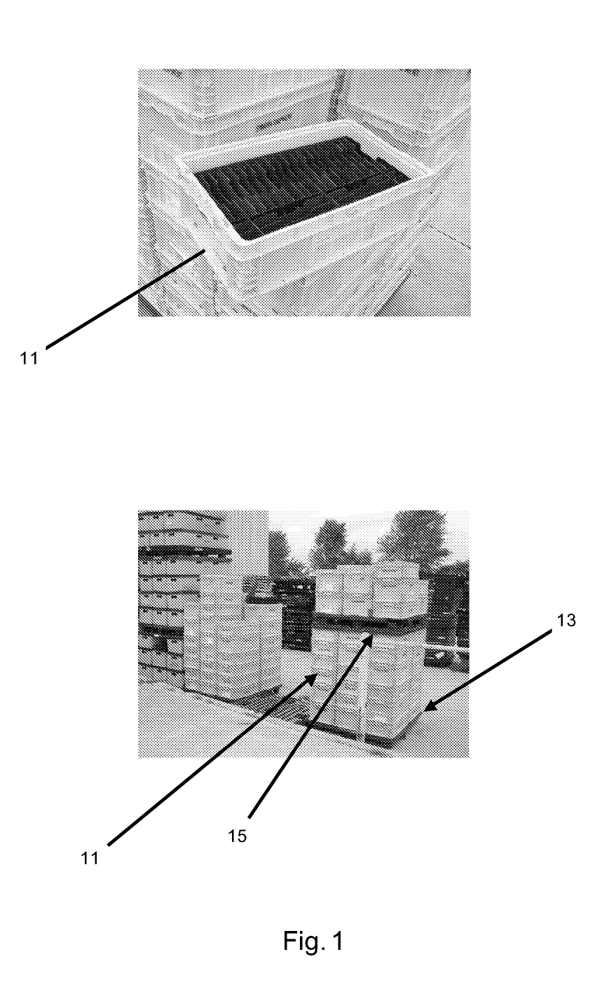

FIG. 1 shows examples of typical returnable packaging used in a returnable packaging system. Examples of returnable packaging include containers 11, pallets 13, and lids 15.

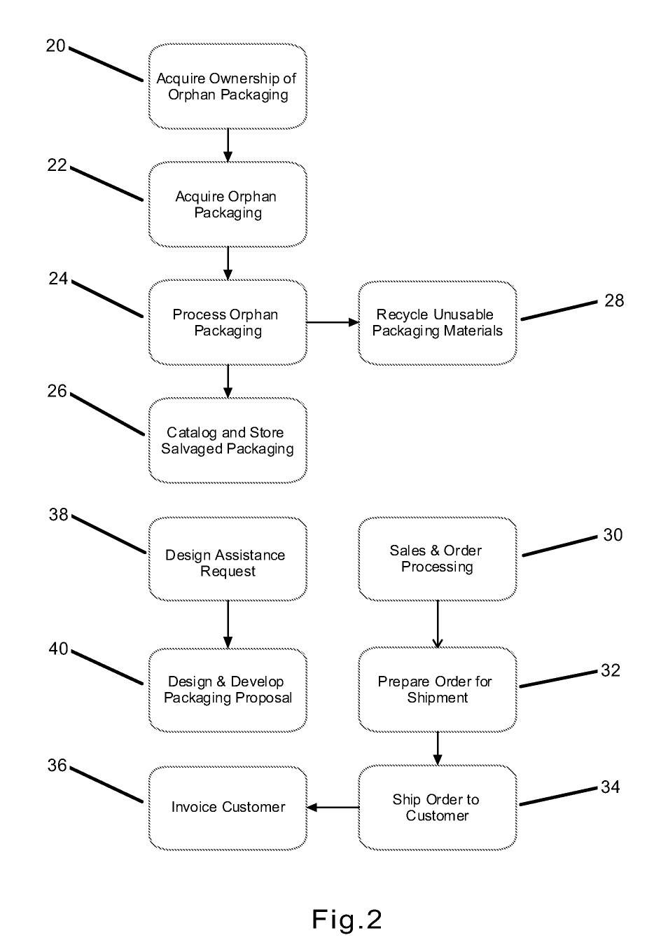

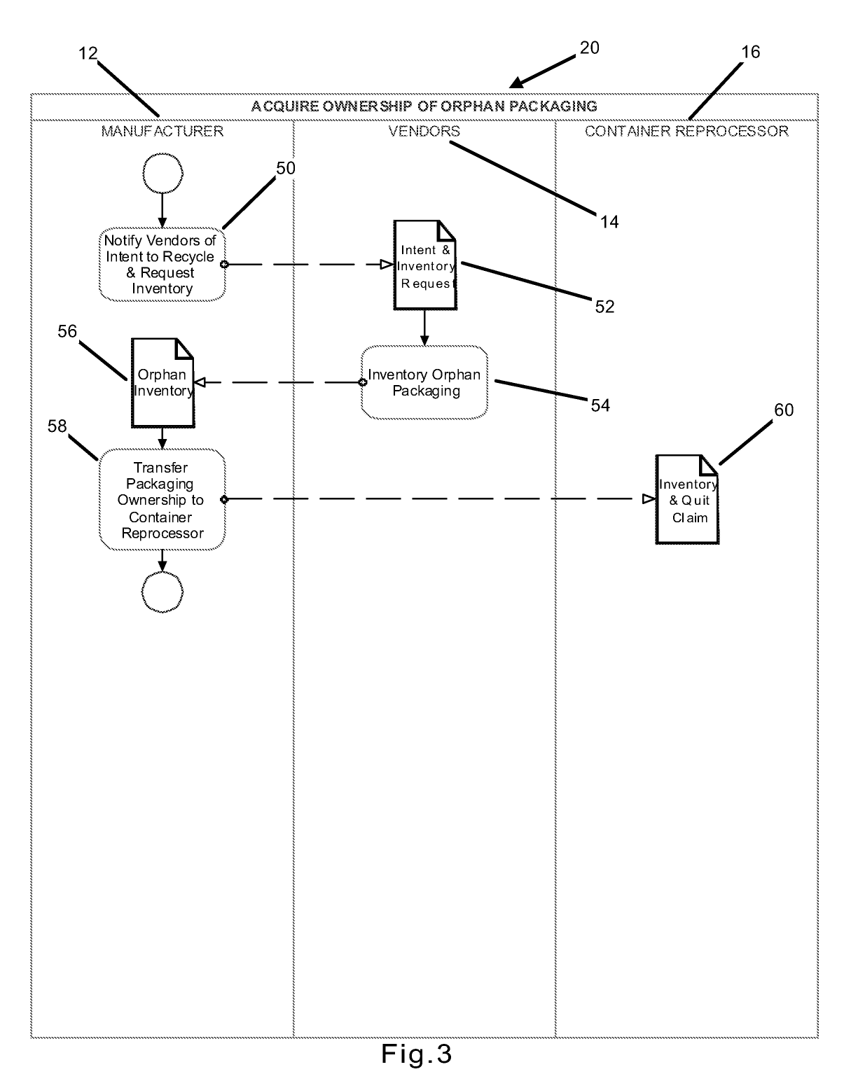

FIGS. 3-9 give detailed illustrations of each exemplary process of FIG. 2.

### Acquiring Ownership of Orphan Packaging

Referring to FIG. 2, ownership of the orphan packaging is acquired, as represented by block 20. Referring to FIG. 3, an exemplary process of acquiring ownership includes manufacturer 12 requesting inventory and notifying vendor 14 of its intent to reuse the orphan packaging, as represented by block 50, via notification 52. In one embodiment, notification 52 includes an inventory request and a notification of intent. An inventory request may be a request that vendor 14 catalog its stock of abandoned returnable packaging and send a list of the stock to container reprocessor 16 or manufacturer 12. A notification of intent may be a notice to vendor 14 that container reprocessor 16 intends to acquire ownership of the abandoned returnable packaging and to reuse or recycle the packaging. Notification 52 may be verbal, an electronic or paper document, or some other suitable form of communication. The chosen form of communication may be stored on a storage mechanism.

The orphan packaging may include but is not limited to containers, lids, dunnage, and pallets. In one embodiment, manufacturer 12 originally purchased the orphan packaging and is thus the rightful owner of the packaging at the time of the inventory request. As such, vendor 14 has no legal ownership of the orphan packaging at the time of the inventory request. As such, container reprocessor 16 only must acquire ownership from manufacturer 12 and not vendor 14.

Another exemplary process of acquiring ownership includes vendor 14 cataloguing its stock of orphan packaging, as represented by block 54, and sending manufacturer 12 notification 56. In one embodiment, notification 56 contains the orphan packaging inventory of vendor 14. Notification 56 may be verbal, an electronic or paper document, or some other suitable form of communication. The chosen form of communication may be stored on a storage mechanism.

As represented by block 58, another exemplary process of acquiring ownership includes manufacturer 12 transferring ownership of the orphan packaging to container reprocessor 16 via agreement 60. In one embodiment, agreement 60 is a quit claim statement that transfers the ownership in the orphan packaging from manufacturer 12 to container reprocessor 16. In another embodiment, manufacturer 12 sells the orphan packaging to container reprocessor 16 for some nominal amount. In another embodiment, manufacturer 12 gives the orphan packaging to container reprocessor 16 as a gift. In another embodiment, manufacturer 12 and container reprocessor 16 execute a blanket agreement to transfer ownership of the orphan packaging to container reprocessor 16 upon its receipt of the orphan packaging. In yet another embodiment, manufacturer 12 declares, either by word or action, the orphan packaging abandoned and container reprocessor 16 takes possession and assumes ownership.

### Acquire Orphan Packaging

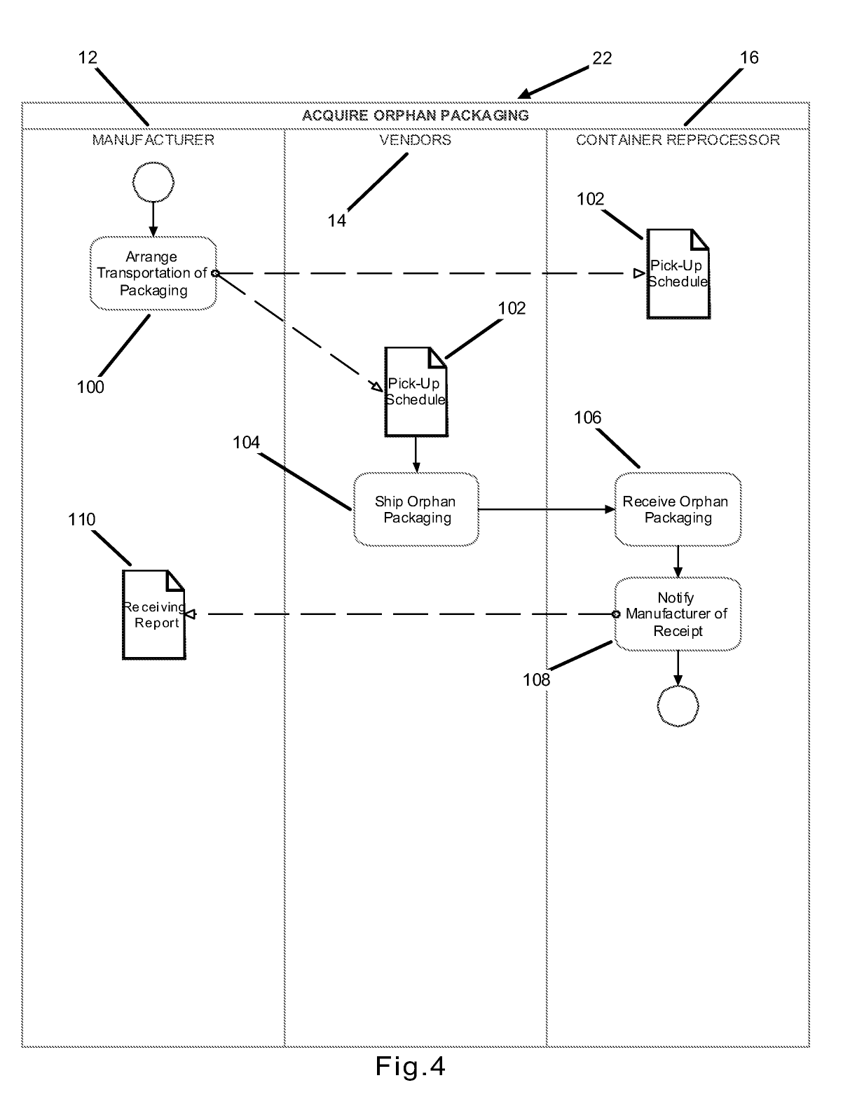

Referring to FIG. 2, the orphan packaging being held at a vendor's storage area is acquired, as represented by block 22. Referring to FIG. 4, an exemplary process of acquiring packaging includes manufacturer 12 handling the shipping arrangements and costs associated with routing the orphan packaging to container reprocessor 16, as represented by block 100. In one embodiment, manufacturer 12 sends pick-up schedule 102 to both vendor 14 and container reprocessor 16. Pick-up schedule 102 may contain the arrangement information for a successful shipment and receipt of the orphan packaging.

Another exemplary process of acquiring packaging includes vendor 14 shipping the orphan packaging to container reprocessor 16 according to the arrangements of pick-up schedule 102, as represented by block 104.

Another exemplary process of acquiring packaging includes container reprocessor 16 successfully receiving the shipment of orphan packaging from vendor 14 and notifying manufacturer 12 of said successful receipt, as represented by blocks 106 and 108. In one embodiment, container reprocessor 16 sends receiving report 110 to manufacturer 12 as notification of said successful receipt. Receiving report 110 may contain a list of the materials received in the shipment. Receiving report 110 may be communicated verbally or through an electronic or other document. The information of receiving report 110 may be stored through a storage mechanism.

### Process Orphan Packaging

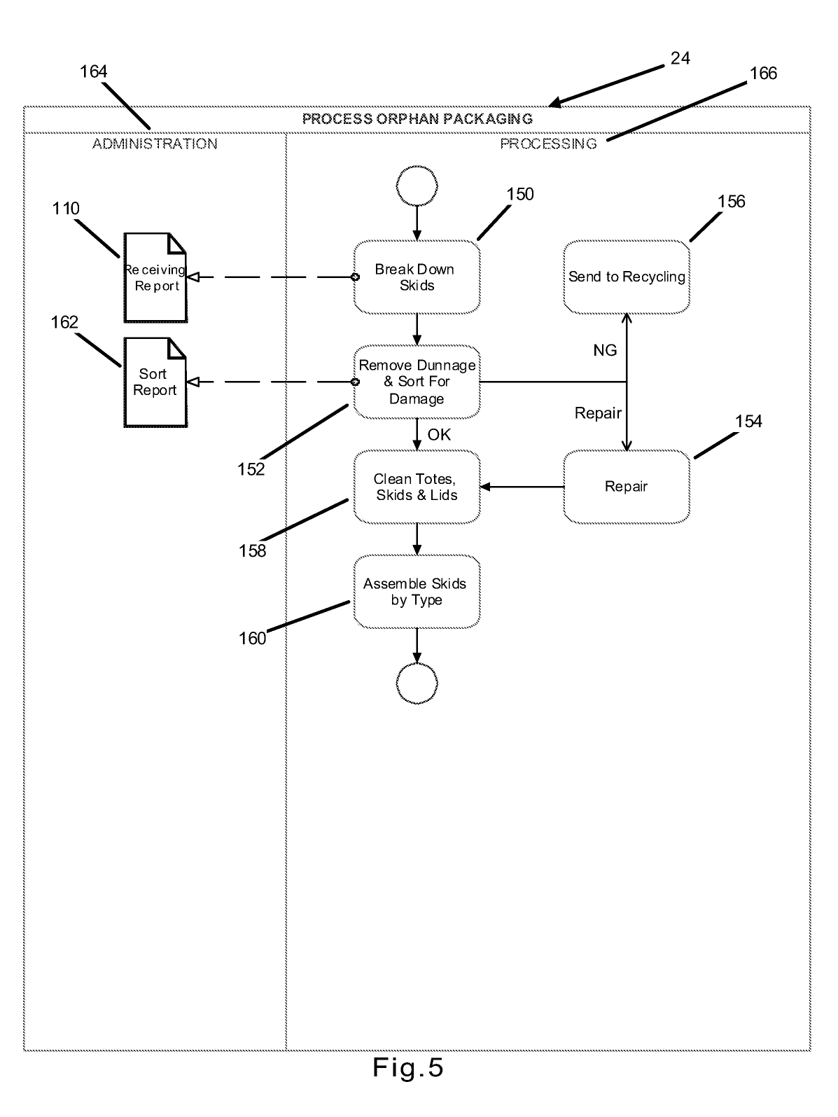

Referring to FIG. 2, the orphan packaging is processed and readied for reuse, as represented by block 24. Referring to FIG. 5, container reprocessor 16 may be divided into an administration division 164 and a processing division 166 in one embodiment. Each division may play a role in the operation of the present invention. Container reprocessor 16 may use other suitable methods or divisions for delegating responsibilities for the successful operation of the present invention.

An exemplary method of processing packaging includes removing the packaging from the pallets and breaking down the pallets, as represented by block 150. In one embodiment, processing division 166 generates receiving report 163 that confirms the receipt of the orphan packaging. In one embodiment, receiving report 163 is sent to administration division 164. Receiving report 163 may contain a list of the materials received in the shipment. Receiving report 163 may be communicated verbally or through an electronic or other document. The information of receiving report 163 may be stored through a storage mechanism.

Another exemplary method of processing packaging includes removing all dunnage and Kanban holders from the containers and sorting the packaging based on condition, size, and shape, as represented by block 152. In one embodiment, the packaging is sorted into unusable, repairable, and reusable groups. In one embodiment, a sort report 162 is generated and sent to administration division 164. Sort report 162 may contain an inventory of the available packaging in each sorted group.

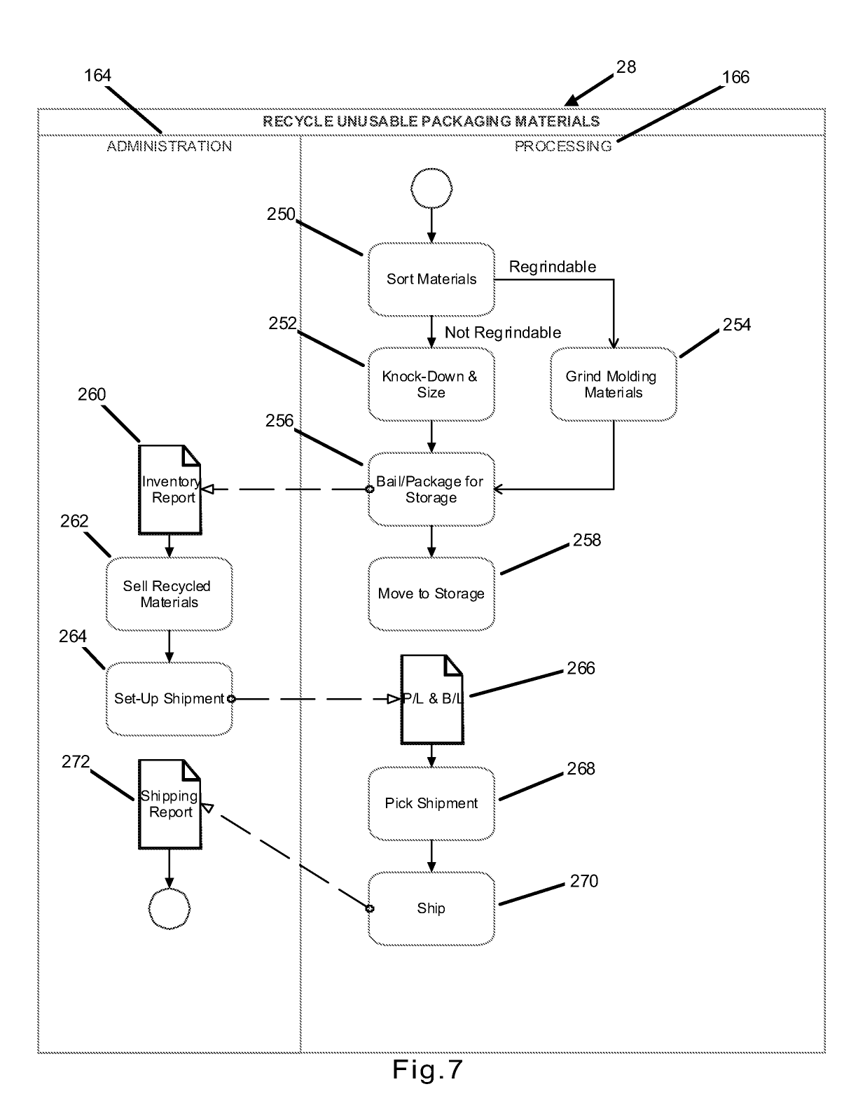

Another exemplary method of processing packaging includes dispatching the sorted packaging, as represented by blocks 154, 156, and 158 of FIG. 5. In one embodiment, the unusable packaging is recycled, as referenced in block 28 of FIG. 2 and FIG. 7. In one embodiment, the repairable packaging is repaired and prepared for cleaning. In one embodiment, the reusable packaging and repaired packaging are cleaned and refurbished. This may include but is not limited to removing all labels, cleaning containers, pallets, and lids, and replacing Kanban holders. Cleaning, refurbishing, and dispatching the packaging may be done manually with pressure sprayers, scrubbers, or other washing devices. Alternatively, cleaning, refurbishing, and dispatching the packaging may be done automatically. In one embodiment, an automatic wash tunnel may be used to clean the packaging and sort the packaging into unusable, repairable, and reusable groups.

Another exemplary method of processing packaging includes designing and constructing new pallets to hold the salvaged packaging, as represented by block 160. In one embodiment, the pallets are designed and loaded with packaging in accordance with the packaging type, size, shape, etc. In another embodiment, the pallets are designed and loaded in accordance with an order for packaging.

### Catalog and Store Salvaged Packaging

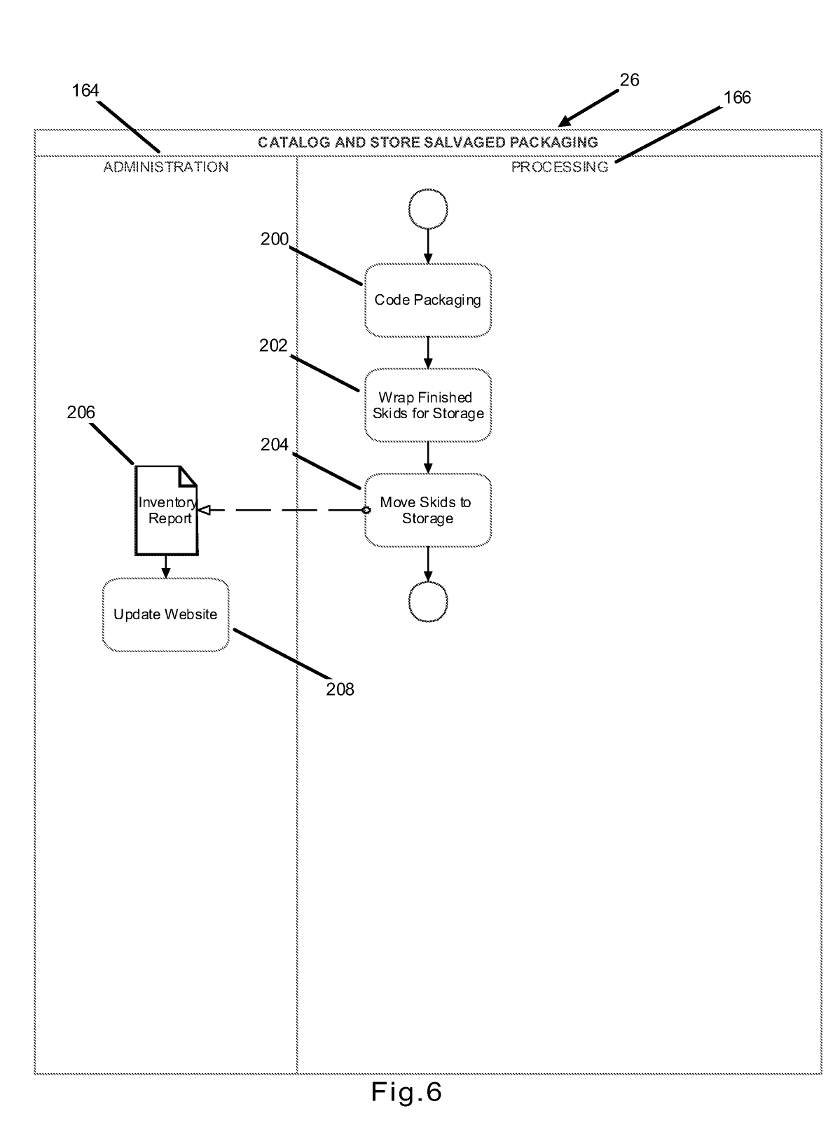

Referring to FIG. 2, the containers are catalogued and stored for future distribution or reuse, as represented by block 26. Referring to FIG. 6, an exemplary process of cataloguing and storing includes associating codes with each container, as represented by block 200. The codes may be used as identification for each container. In one embodiment, the codes are bar codes applied to the containers. In one embodiment, the codes are tags that transmit a wireless signal including an identification code. In one embodiment, the codes are microdots applied to the containers. In yet another embodiment, the codes use holographic technology to identify the containers.

An exemplary process of cataloguing and storing includes preparing the loaded pallets for storage, as represented by block 202. In one embodiment, the pallets are wrapped or enclosed in a protective material, such as heavy plastic, for protection from the elements.

Another exemplary process of cataloguing and storing includes moving the loaded pallets to storage, as represented by block 204. In one embodiment, the pallets are placed in an outside storage area. Alternatively, the pallets may be placed in a warehouse or other storage facility. In one embodiment, a grid system is utilized for tracking inventory location within the storage area. The grid system may be used to quickly identify the exact location of each pallet in the storage area.

Another exemplary process of cataloguing and storing includes updating inventory on a website, as represented by block 208. In one embodiment, inventory report 206 is created and sent to administration division 164. Inventory report 206 may contain a summary of the available packaging and their respective locations in storage. In one embodiment, the website is updated manually according to information from inventory report 206. In one embodiment, the website is updated automatically. Automatic website updates may be accomplished by scanning or reading the codes associated with the containers. The website may be accessed by potential customers to view the available inventory of containers and packaging.

### Recycle Unusable Packaging Materials

Referring to FIG. 2, unusable packaging materials are recycled, as represented by block 28. Referring to FIG. 7, an exemplary process of recycling unusable materials includes sorting the unusable materials into regrindable and non-regrindable groups, as represented by blocks 250, 252, and 254. Exemplary regrindable materials include plastic containers, lids, and pallets. In one embodiment, the regrindable materials are grinded in-house and sold to a third party broker or molder. Exemplary non-regrindable materials include metal, foam, corrugated paper or plastic, and abandoned parts and components found in the containers. In one embodiment, non-regrindable materials are broken down and sized if possible. In one embodiment, the materials that cannot be recycled are scrapped.

Another exemplary process of recycling unusable materials includes bailing and packaging the unusable materials for storage, as represented by block 256. In one embodiment, the materials are loaded on pallets. In one embodiment, the loaded pallets are wrapped in a durable material, such as plastic, for protection. The pallets may be moved to a storage area, as represented by block 258. In one embodiment, the pallets are placed in an outside storage area. Alternatively, the pallets may be placed in a warehouse or other storage facility. In one embodiment, inventory report 260 is created and sent to administration division 164. Inventory report 260 may contain a list of the recycled materials available for resale or reuse. Inventory report 260 may be communicated verbally or through an electronic or paper document.

Another exemplary process of recycling unusable materials includes selling the recycled materials to third parties, as represented by block 262. In one embodiment, administration division 164 sells recycled materials based on the available inventory. Exemplary sales include selling metal to a scrap broker, selling corrugated paper to a paper recycler, selling corrugated plastic to a plastic lumber manufacturer, and selling grinded plastic packaging to a broker or molder. Another exemplary sale includes selling the abandoned parts and components found in the containers back to manufacturer 12.

Another exemplary process of recycling unusable materials includes shipping the materials to the buyer or consumer, as represented by blocks 264, 268, and 270. In one embodiment, administration division 164 coordinates the shipment. Administration division 164 may create document 266 and forward document 266 to processing division 166. Document 266 may include a Bill of Lading (B/L) and Packing List (P/L). A B/L is a document that may function as a document of title for the shipped materials, as a contract between shipper and carrier for the transportation of the materials, and as a receipt for the shipped materials. A P/L describes each item in the cargo and the amount of each item included in the cargo. Document 266 may be paper or electronic.

As represented by blocks 268 and 270, processing division 166 may locate and load the requested recycled materials and ship them to the buyer or consumer. Upon shipment, processing division 166 may create shipping report 272 and send it to administration division 164. Shipping report 272 may contain a confirmation of the shipment, time and destination of shipment, and the materials shipped. Shipping report may be communicated verbally or through an electronic or other document. The information of shipping report 272 may be stored through a storage mechanism.

### Sales and Order Processing

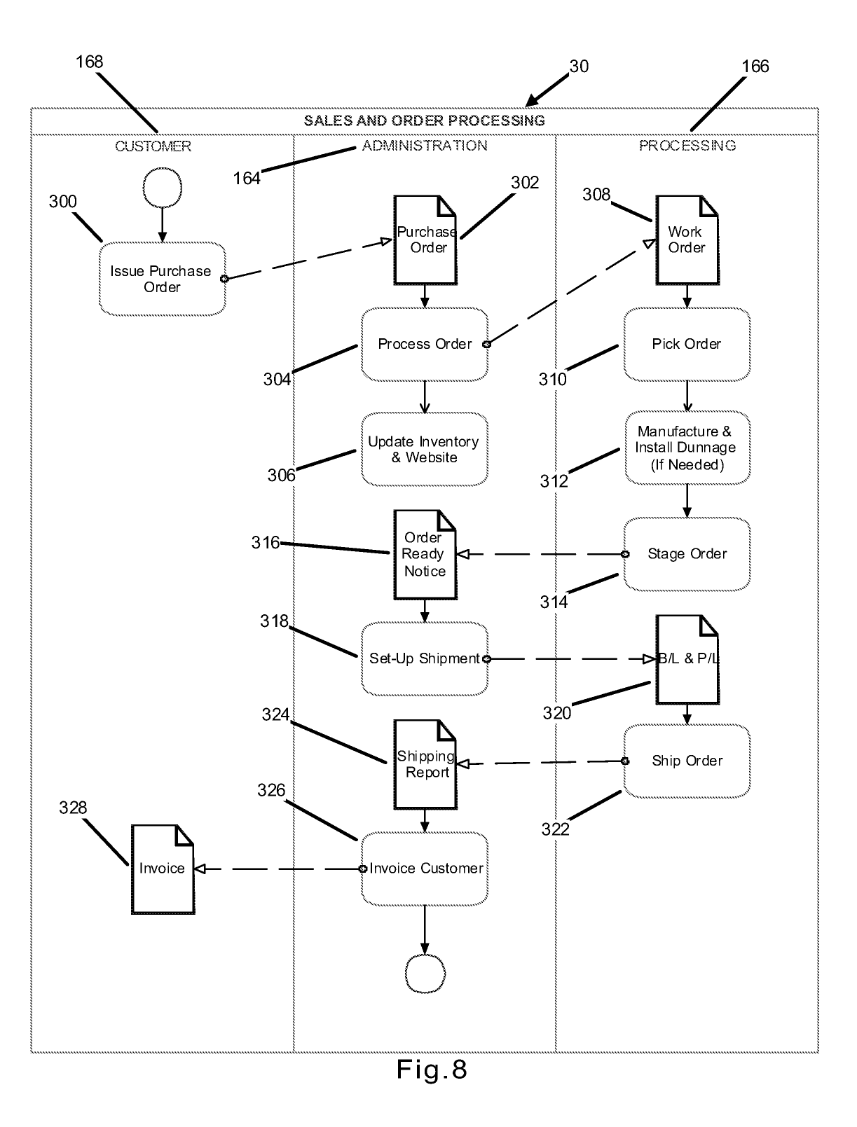

Referring to FIG. 2, sales and orders for the reusable and repaired packaging are processed and shipped, as represented by blocks 30, 32, 34, and 36. A purchase order may be used to request a product or service. Referring to FIG. 8, purchase order 302 may be issued to request an order of packaging, as represented by block 300. In one embodiment, customer 168 creates purchase order 302 and forwards it to administration division 164. Customer 168 may be any individual or entity, including manufacturer 12 and vendor 14, that purchases the reusable or repaired packaging. Purchase order 302 may indicate the type, quantity, and price of the salvaged packaging that container reprocessor 16 will provide customer 168. Purchase order 302 may be communicated verbally or through an electronic or other document.

In one embodiment, purchase order 302 is processed by administration division 164, as represented by block 304. An exemplary method of processing orders includes updating inventory to reflect the requested purchase, as represented by block 306. The inventory may be updated on a website. In one embodiment, the website is updated manually. In one embodiment, the website is updated automatically when the codes associated with the outgoing containers are scanned or read.

Work orders may be used to assign and track the completion of work within a company. An exemplary method of processing orders for packaging includes creating a work order, as represented by work order 308. In one embodiment, administration division 164 creates work order 308 according to purchase order 302 and the available inventory. As such, administration division 164 sends work order 308 to processing division 166 for completion. Work order 308 may be communicated verbally or through an electronic or paper document.

Another exemplary method of processing orders includes preparing the order requested in work order 308, as represented by blocks 310, 312, and 314. Processing division 166 may gather the goods requested in work order 308 from the storage area, as represented by block 310. If requested, processing division 166 may manufacture dunnage and install it in the gathered containers, as represented by block 312. Finally, processing division 166 may stage the order, as represented by block 314. In one embodiment, the order is staged by placing the requested packaging on a pallet and preparing it for shipment. In one embodiment, processing division 166 may notify administration division 164 that the order is ready via notification 316. As such, notification 316 may be communicated verbally or through an electronic or paper document.

Another exemplary method of processing orders includes coordinating the shipment of the ordered materials, as represented by block 318. In one embodiment, administration division 164 creates document 320 and forwards it to processing division 166. Document 320 may contain the shipment information. Document 320 may include a Bill of Lading (B/L) and Packing List (P/L), as described previously. Document 320 may be paper or electronic.

Another exemplary method of processing orders includes shipping the order to customer 168, as represented by block 322. Processing division 166 may ship the order according to arrangements made by administration division 164. In one embodiment, processing division 166 may create shipping report 324 and send it to administration division 164 upon shipment. Shipping report 324 may contain a confirmation of the shipment, time and destination of shipment, and the materials shipped. Shipping report 324 may be communicated verbally or through an electronic or paper document.

Invoices may be used to bill a customer. An exemplary method of processing orders includes invoicing the customer, as represented by block 326. In one embodiment, administration division 164 sends customer 168 invoice 328. Invoice 328 may be sent electronically or by mail and may include a bill for the services and goods rendered by container reprocessor 16.

### Design Assistance Request

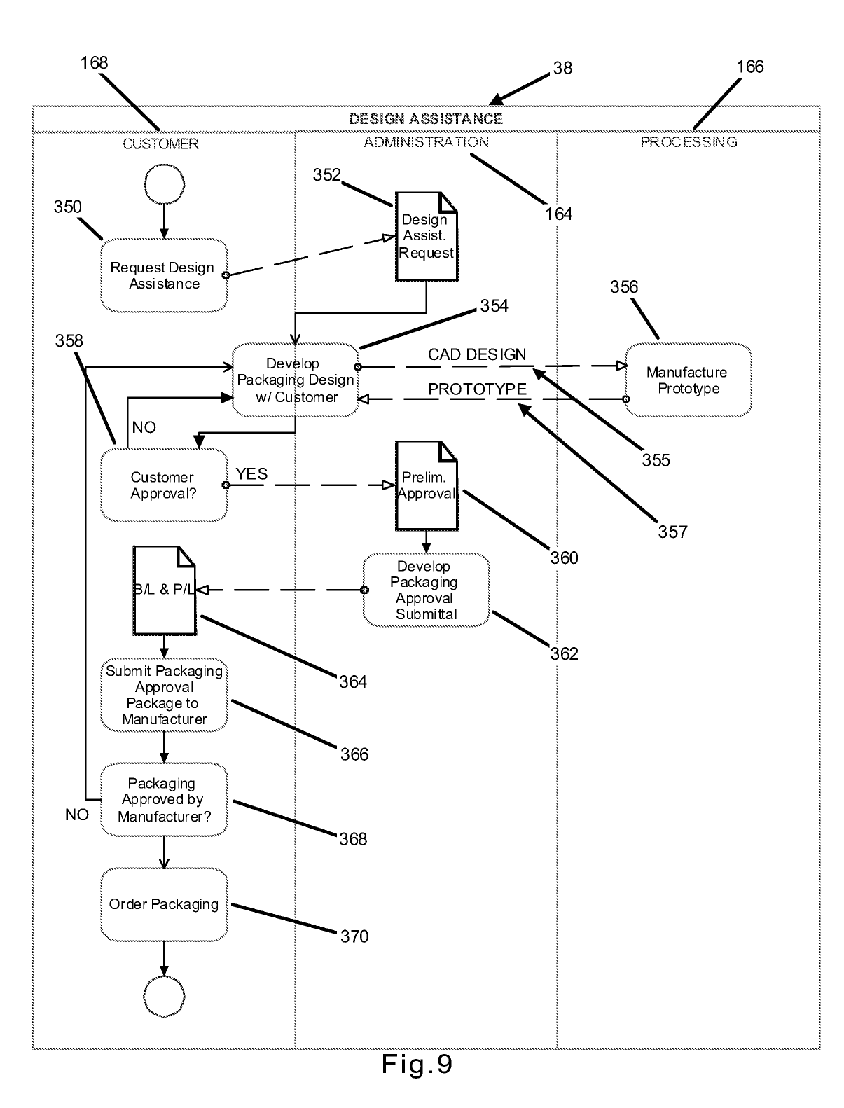

Referring to FIG. 2, requests for custom packaging design and development are received and processed, as represented by blocks 38 and 40. Referring to FIG. 9, customer 168 may request assistance with the design of the custom packaging, as represented by block 350. In one embodiment, customer 168 is vendor 14. Exemplary custom packaging may include dunnage, containers, labeling, pallets, and lids. An exemplary request includes customer 168 sending request 352 to administration division 164. Request 352 may include a description of the desired packaging, such as the type of packaging, space requirements, cargo descriptions, drawings, etc. Request 352 may be communicated verbally or through an electronic or paper document.

An exemplary process of design includes developing the custom design of packaging with customer 168, as represented by block 354. The custom design of the packaging may be to contain or enclose goods that are shipped from one location to another location. The custom design may also be to protect from damage goods that are shipped from one location to another location. In one embodiment, the goods are shipped in the custom packaging from a vendor to a manufacturer. The custom design of the packaging may meet or exceed a minimum threshold of protection from damage for the goods contained in the packaging. The custom design may also capture the packaging requirements set forth in request 352. In one embodiment, the custom design may be described in a specification or written description. In another embodiment, the custom design may be illustrated in a sketch or drawing. The custom design of packaging may be created with a computer or without a computer, such as by hand.

Computer-aided design (CAD) is a tool for industrial design applications. In one embodiment of developing the custom design of packaging, administration division 164 uses a CAD program to create CAD design 355. In one embodiment, CAD design 355 is created interactively with customer 168. Interactive design may be accomplished in a variety of ways, such as in person, via a public network such as the internet, wirelessly, or via a private network. In one embodiment, CAD design 355 is a sketch or drawing of the packaging design.

Another exemplary process of design includes manufacturing a prototype, as represented by block 356. In one embodiment, processing division 166 manufactures prototype 357 based on CAD design 355. Prototype 357 may be a model of the designed packaging used for evaluation and review. An exemplary method of manufacturing prototype 357 includes cutting and building dunnage directly from the CAD files. This direct manufacturing from CAD files allows custom dunnage to be quickly available to customers.

Another exemplary method of manufacturing prototype 357 includes selecting and modifying packaging from salvage inventory to create custom packaging for prototype 357. Salvage inventory may include reused and recycled packaging. Packaging from salvage inventory that is similar to the custom design may be selected to create custom packaging. In one embodiment, packaging from salvage inventory that meets minimum criteria for the custom design is selected to create custom packaging. Minimum criteria may include constraints on the size, shape, material, cost, or protection capability of the packaging.

In one embodiment, the selected packaging from salvage inventory does not require modification to meet the requirements of the custom design. In another embodiment, the selected packaging requires modification to meet the requirements of the custom design. The requirements of the custom design may be contained in request 352. Modifying the selected packaging may result in packaging that meets the requirements of the custom design as best as possible without exceeding specified limitations, e.g. physical or financial limitations. Modifying the selected packaging may include altering the physical characteristics of the packaging by cutting, welding, bending, or molding the packaging, or by adding further dunnage or other supports or padding to the packaging, or a combination of alterations and additions to the packaging.

Another exemplary process of design includes getting customer approval of prototype 357. As represented by block 358, customer 168 evaluates prototype 357. Customer 168 may deem prototype 357 suitable for its application and send approval 360 to administration division 164. Approval 360 may be communication, either verbal or in electronic or paper document form, that prototype 357 is adequate for production. Alternatively, customer 168 may reject prototype 357. As such, customer 168 and administration division 164 make changes to CAD design 355 and manufacture a new prototype for evaluation, as represented by blocks 354 and 356.

Another exemplary process of design includes submitting a packaging approval package to manufacturer 12, as represented by blocks 362 and 366. In one embodiment, administration division 164 develops a packaging approval package on behalf of customer 168 once prototype 357 is approved. As such, customer 168 may submit the packaging approval package prepared by administration division 164 to manufacturing entity 12.

An exemplary packaging approval package is approval submittal 364. Approval submittal 364 may include a Bill of Lading (B/L), a Packing List (P/L), as described previously, and any packaging approval request forms that may be required by manufacturer 12. The documents and forms of approval submittal 364 may be paper or electronic. In addition, approval submittal 364 may include a prototype sample, such as prototype 357, of the proposed custom packaging. In one embodiment, actual parts are packed in the custom packaging prototype. Customer 168 may review approval submittal 364 prior to submitting it to manufacturing entity 12.

Exemplary functions of approval submittal 364 include providing a basis for approval of the custom packaging for production use, allowing customer 168 to evaluate the design and sales terms of the custom packaging, and providing a basis for generating purchase orders for the custom packaging.

As represented in blocks 366 and 368, customer 168 may submit approval submittal 364 to manufacturer 12. Manufacturer 12 may reject the custom packaging. As such, customer 168 and administration division 164 may make changes to CAD design 355 and manufacture a new prototype for evaluation, as represented by blocks 354 and 356. Customer 168 and administration division 164 may also make changes to the forms and documents of approval submittal 364. Manufacturer 12 may approve the custom packaging. As such, customer 168 may order the custom packaging from container reprocessor 16, as represented by block 370.

Once customer 168 and manufacturer 12 have approved the custom packaging design, container reprocessor 16 may manufacture custom packaging based on the approved prototype 357. Exemplary methods of manufacturing custom packaging include direct manufacturing from CAD files and selecting and modifying packaging from salvage inventory to create custom packaging. Both methods are discussed above.

In another exemplary embodiment, a server computer is provided that allows manufacturers to access software that enables the process of creating a custom design, allows for the selecting of one of the inventory on the web site for the packaging, and also provides for allowing the user to modify the selected packaging to accommodate the custom design. This server utilizes the inventory database described above, and also may provide access to the CAD Program described above, or may enable the uploading of a file created by such a CAD program.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of reusing packaging used to ship manufactured goods, wherein the packaging has a lifecycle that terminates at the completion of a program for the manufactured goods, said method comprising the steps of:
acquiring ownership of the packaging;
acquiring possession of said packaging;
cataloguing said packaging; and
shipping said packaging to customers.

2. The method of claim 1, wherein said shipping step includes the manufacturing entity providing the shipping of said packaging.

3. The method of claim 1, wherein said cataloguing step includes sorting said packaging into one of a plurality of groups based on at least one of physical characteristics and condition.

4. The method of claim 3, wherein said cataloguing step includes sorting said packaging into a plurality of groups, said plurality of groups including reusable, repairable, and unusable groups.

5. The method of claim 4, wherein said cataloguing step includes at least one of cleaning and readying said packaging of said reusable group for reuse.

6. The method of claim 4, wherein said cataloguing step includes at least one of repairing, cleaning, and readying said packaging of said repairable group for reuse.

7. The method of claim 4, wherein said cataloguing step includes at least one of recycling or scrapping said packaging of said unusable group.

8. The method of claim 1, wherein said cataloguing step includes at least one of
associating identification codes with each container; and
tracking inventory with said identification codes.

9. The method of claim 1, wherein said cataloguing step includes posting the available inventory of said packaging on an inventory website.

10. The method of claim 9, further comprising the step of making said inventory website available for customer access.

11. The method of claim 1, wherein said cataloguing step includes storing said packaging in a storage area.

12. The method of claim 11, wherein a grid system is utilized for locating said stored packaging.

13. The method of claim 11, wherein said storing step includes at least one of placing said packaging on pallets and wrapping said packaging in protective material.

14. A method of creating packaging used to ship manufactured goods, wherein the packaging has a lifecycle that terminates at the completion of a program for the manufactured goods, said method comprising the steps of:
creating a custom design of the packaging;
selecting reused or recycled packaging from an inventory of packaging including at least one of reused and recycled packaging, the selected packaging being similar to said custom design; and
modifying said reused or recycled packaging to best match said custom design.

15. The method of claim 14, wherein said creating step includes using a CAD program to design said packaging.

16. The method of claim 15, wherein said creating step includes interacting with said CAD program and said customer via the internet.

17. The method of claim 15, wherein said modifying step includes manufacturing packaging directly from a CAD program file.

18. A server system for connection to a network, wherein the server system comprises:
a server computer;
a software program on said server computer for performing a method of designing packaging used to ship manufactured goods, wherein the packaging has a lifecycle that terminates at the completion of a program for the manufactured goods, the method comprising the steps of:
creating a custom design of packaging;
selecting reused or recycled packaging from an inventory of packaging including at least one of reused and recycled packaging, the selected packaging being similar to said custom design; and
modifying said reused or recycled packaging to best match said custom design.

19. The server system of claim 18, wherein said software program uses a CAD program to design said packaging in said creating step.

20. The server system of claim 18, wherein said software program includes the step of uploading a CAD program file and said modifying step includes manufacturing packaging directly from the CAD program file.
